(19) United States
(12) Patent Application Publication
(10) Pub. No.: US 2010/0239194 A1
(43) Pub. Date: Sep. 23, 2010

(54) DISK DRIVE DEVICE IMPROVED IN HANDLING PROPERTY

(75) Inventor: Mitsuo KODAMA, Shizuoka (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ALPHANA TECHNOLOGY CO., LTD., Shizuoka (JP)

(21) Appl. No.: 12/723,481

(22) Filed: Mar. 12, 2010

(30) Foreign Application Priority Data
Mar. 17, 2009 (JP) 2009-064174

(51) Int. Cl. F16C 32/06

(52) U.S. Cl. 384/107

(57) ABSTRACT

A disk drive device includes a base member, a hub member, a shaft, a flange, a sleeve, a thrust dynamic pressure generation portion including thrust dynamic pressure grooves such that thrust dynamic pressure is generated in a thrust space, a radial dynamic pressure generation portion including radial dynamic pressure grooves such that radial dynamic pressure is generated in a radial space, a lubricant filled in the thrust space in the thrust dynamic pressure generation portion and the radial space in the radial dynamic pressure generation portion, a capillary seal portion for holding the lubricant in the thrust space and the radial space, and a circulation pathway by which the thrust dynamic pressure generation portion and the radial dynamic pressure generation portion communicate with each other in order to circulate the lubricant. At least one of the areas among where the thrust dynamic pressure groove is formed and where the radial dynamic pressure groove is formed is made of an impact absorption body with a coefficient of elasticity less than or equal to 20 GPa.

### CROSS-REFERENCE TO RELATED APPLICATION

This application is based upon and claims the benefit of priority from the prior Japanese Patent Application No. 2009-064174, filed on Mar. 17, 2009, the entire content of which is incorporated herein by reference.

### BACKGROUND OF THE INVENTION

1. Field of the Invention

The present invention relates to a disk drive device, and in particular, to a structure of a disk drive device in which the assembly and handling of the disk drive device are made easy.

2. Description of the Related Art

Conventionally, dynamic bearings utilizing fluid pressures in a lubricant, such as oil, that is placed between a shaft and a sleeve in order to support both in a relatively rotatable manner, have been proposed as suitable bearings for spindle motors used in disk drive devices for driving recording disks such as hard disks. Among such dynamic bearings, the structure in which the lubricant is filled continuously in the whole minute gap with which dynamic pressure generation portions in the bearing are structured, has been developed for practical use. For example, Japanese Patent Application Publication No. 2000-304052 discloses an ordinary example of the structure.

In a spindle motor using such a fluid dynamic bearing, for example, herringborn-shaped dynamic pressure grooves for generating dynamic pressures are formed on at least either the outer circumferential surface of a shaft, which is integral with a rotor, or the inner circumferential surface of a sleeve through which the shaft is rotatably inserted, in a state where the dynamic pressure grooves are spaced apart from each other in the axial direction. Thereby, radial bearing units are structured by the aforementioned dynamic pressure grooves and the lubricant held in the gap between the outer circumferential surface and the inner circumferential surface. In addition, a thrust bearing unit is structured by: the upper surface of a disk-shaped flange, projecting outwardly in the radial direction from the outer circumferential surface at one end of the shaft; the flat surface of a shoulder portion formed on the sleeve; and the lubricant held between these two surfaces. Further, another thrust bearing unit is structured by: the lower surface of the flange; a counter plate for closing one opening of the sleeve; and the lubricant held between these two surfaces. Each of these thrust bearing units also generates thrust dynamic pressure by the use of a herringborn-shaped dynamic pressure groove formed on at least one of the two surfaces, which faces each other. The radial dynamic pressure groove in the radial bearing unit and the thrust dynamic pressure groove in the thrust bearing unit respectively generate maximum dynamic pressure at the herringborn-shaped joints in accordance with rotation of the rotor, thereby supporting the load acting on the rotor.

As stated above, when each dynamic pressure groove surface of the radial bearing unit and the thrust bearing unit, on which a dynamic pressure groove is formed, and the surface facing the dynamic pressure groove surface (hereinafter, the surface facing the dynamic pressure groove surface is referred to as the “facing surface”), have reached a predetermined relative rotational speed, dynamic pressure is generated in the lubricant filled between both. With the dynamic pressure, the gap between the dynamic pressure groove surface and the facing surface can be maintained in a non-contact state. However, when the rotational speed is not enough, including the state when stopped, dynamic pressure is not generated, causing the dynamic pressure groove surface and the facing surface to be directly in contact with each other. In such a state, if impact acceleration is applied to the disk drive device when, for example, something has fallen thereon, both surfaces are to be in contact with each other in a state where kinetic energy is applied to both, the kinetic energy being given by the mass of the portion including a hub and the disk, etc., and by the impact acceleration, in which the portion is considered to be substantially integral with both surfaces. When the dynamic pressure groove surface and the facing surface are in contact with each other in this way, kinetic energy is applied to the dynamic pressure groove surface and then absorbed, as mechanical energy, by the elasticity of the dynamic pressure groove surface. In this case, the stress applied to the contacted surface is approximately proportional to the square root of the coefficient of elasticity of the dynamic pressure groove surface. However, in a conventional dynamic pressure groove surface, a material with high hardness is used in order to avoid wear. The coefficient of elasticity of such a material has been as high as 200 GPa. As such a material, a material such as a stainless steel, which is strong against a stress, has been used. Even in the case, however, the influence made by impact cannot be avoided, and, accordingly, deformation of the dynamic pressure groove surface or powder produced by wear have been sometimes caused by even small impact acceleration. When the dynamic pressure groove surface has been deformed, the bearing performance is deteriorated, thus deteriorating the characteristics of the disk drive device or the quality thereof. In addition, when the produced powders are present between the dynamic pressure groove surface and the facing surface, there have been cases where the wear of the dynamic pressure groove surface is accelerated during relative rotation, and, accordingly, the dynamic pressure groove surface is burned in a short period of time, and the disk drive device can be no longer used.

Such application of impact acceleration mostly occurs in assembling a disk drive device, and therefore it is necessary to assemble a disk drive device with utmost attention, causing the problem of the workability being deteriorated.

In addition, there is the case where impact acceleration is applied in handling a disk drive device after being assembled or in handling an apparatus in which the disk drive device is mounted. In particular, in a disk drive device in which many recording disks are mounted, the total mass on which the impact acceleration acts is increased, and hence significant stress is caused on the dynamic pressure groove surface even when the applied impact is small. Accordingly, there has been a limitation in which the number of the recording disks mountable in a disk drive device is limited or in which the disk drive device cannot be used in applications subject to impact, such as mobile devices. Accordingly, it is necessary to handle a disk drive device after being assembled or an apparatus in which the disk drive device is mounted with utmost attention, also deteriorating work efficiency.

Further, in the case of a disk drive device, when there is a large difference between the volume resistivity of the lubricant used in a bearing unit and that of an area of which each dynamic pressure groove surface is composed, static electricity has sometimes been generated during the assembly of the disk drive device. Thereby, the relevant members have been degraded or dust, etc., has been adsorbed. In particular, the adsorption of dust causes head crashes. In this case, it is necessary to remove the static electricity in the assembly process of a disk drive device or to perform the assembly work slowly in order not to generate static electricity, thereby also deteriorating the work efficiency.

### SUMMARY OF THE INVENTION

The present invention has been made in view of these situations, and a purpose of the invention is to provide a disk drive device in which the assembly and handling of the disk drive device are made easy.

In order to solve the aforementioned problems, a disk drive device according to an embodiment of the present invention comprises a base member, a rotating member configured to rotate a recording disk, and a bearing unit configured to rotatably support the rotating member relative to the base member. The bearing unit includes: a shaft; a housing member with a hollow portion in which at least part of the shaft is housed and relative rotation is allowed; a thrust dynamic pressure generation portion configured to generate dynamic pressure in the thrust direction in a thrust space with a predetermined gap, the thrust space being formed in the rotational axis direction of the rotating member by the shaft and the housing member, by the relative rotation between areas in the thrust space, the areas facing each other and a thrust dynamic pressure groove being formed on at least one of the areas; a radial dynamic pressure generation portion configured to generate dynamic pressure in the radial direction in a radial space with a predetermined gap, the radial space being formed in the radial direction that is perpendicular to the rotational axis direction of the rotating member by the shaft and the housing member, by the relative rotation between areas in the radial space, the areas facing each other and a radial dynamic pressure groove being formed on at lest one of the areas; and a lubricant filled in the thrust space in the thrust dynamic pressure generation portion and the radial space in the radial dynamic pressure generation portion. At least one of the areas among where the thrust dynamic pressure groove is formed and where the radial dynamic pressure groove is formed is an impact absorbing body with a coefficient of elasticity less than or equal to 20 GPa.

According to the embodiment, at least one of the areas among where the thrust dynamic pressure groove is formed and where the radial dynamic pressure groove is formed is structured with an impact absorbing body with a coefficient of elasticity less than or equal to 20 GPa. The coefficient of elasticity is approximately one tenth ( 1/10) of the coefficient of elasticity of a conventionally-used material such as a stainless steel, the coefficient of elasticity of which being 200 GPa. As a result, although the kinetic energy of impact is applied to the dynamic pressure groove surface when the dynamic pressure groove surface and the facing surface is contact with each other, the impact energy is absorbed by the impact absorbing body of which the dynamic pressure groove surface is made. Because the stress applied to these surfaces is approximately proportional to the square root of the coefficient of elasticity, the stress is reduced to approximately one third (⅓) in comparison with the case where a stainless steel, etc., has been conventionally used. As a result, it becomes unnecessary to pay utmost attention to an impact as before. Thereby, the assembly work can be done more rapidly than before, allowing work efficiency to be improved.

The impact absorbing body can be used to cover the surface of a base material as a material different from the base material of which the dynamic pressure groove surface is made. As a material of which the impact absorbing body is made, for example, a polyetherimide resin can be used. Further, the volume resistivity of the impact absorbing body may be adjusted by making the impact absorbing body conductive with a conduction material such as carbon fiber mixed into the resin. In this case, it becomes possible to adjust the volume resistivity of the resin material to be similar to that of the lubricant, reducing the static electricity generated between the dynamic pressure groove surface and the lubricant. As a result, it becomes unnecessary to pay utmost attention to static electricity. Thereby, the assembly work can be done more rapidly than before, allowing work efficiency to be improved.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic view illustrating the internal structure of a disk drive device according to the present embodiment;

FIG. 2 is a partial cross-sectional view illustrating a fixed portion, a rotating body portion, and a bearing unit of the disk drive device according to the present embodiment; and

FIG. 3 is a perspective view of a shaft provided with a flange according to the present embodiment.

### DETAILED DESCRIPTION OF THE INVENTION

The invention will now be described by reference to the preferred embodiments. This does not intend to limit the scope of the present invention, but to exemplify the invention.

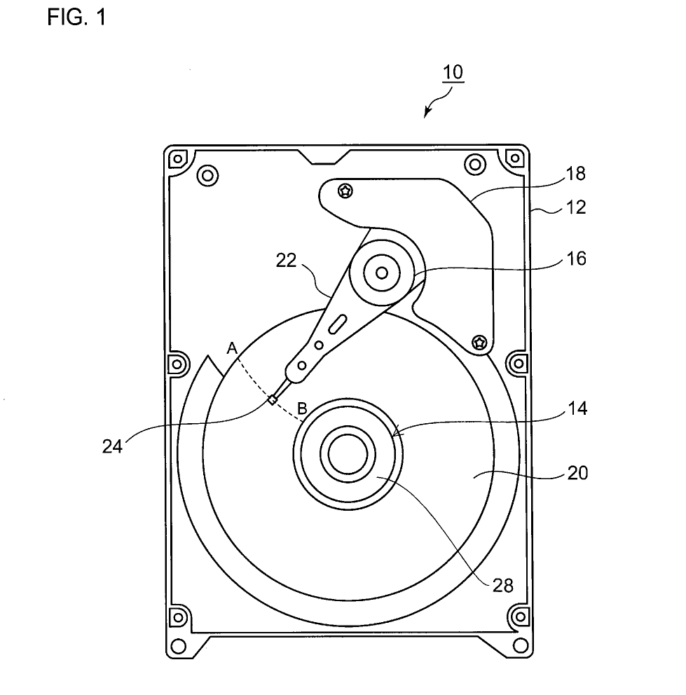

Hereinafter, the preferred embodiment of the present invention will be described based on the accompanying drawings. FIG. 1 is a schematic view illustrating the internal stricture of a hard disk drive device (HDD) 10, an example of a disk drive device according to the present embodiment. FIG. 1 illustrates a state where the cover has been removed in order to expose the internal structure.

A brushless motor 14, an arm bearing unit 16, a voice coil motor 18, etc., are mounted on the upper surface of a base member 12. The brushless motor 14 may be replaced by, for example, a spindle motor with twelve slots and eight magnetized poles. The brushless motor 14 rotationally drives a recording disk 20 on which data can be recorded, for example, magnetically. The brushless motor 14 is driven by a three-phase drive current consisting of a U-phase, a V-phase, and a W-phase. The arm bearing unit 16 supports, in a swing-free manner, a swing arm 22 within a movable range AB. The voice coil motor 18 makes the swing arm 22 swing in accordance with external control data. A magnetic head 24 is fixed to the tip of the swing arm 22. When the HDD 10 is in an operation state, the magnetic head 24 moves, with the swing of the swing arm 22, above the surface of the recording disk 20 with a slight gap between them and within the movable range AB, thereby reading/writing data. In FIG. 1, point A corresponds to the position of the outermost circumferential recording track of the recording disk 20, and point B corresponds to the position of the innermost circumferential recording track thereof. The swing arm 22 may be moved to the waiting position provided in the side of the recording disk 20 when the HDD 10 is in a stopped state.

A hub member 28, which is rotated by the brushless motor 14, is exposed at a position that is slightly shifted in the longitudinal direction from the approximate center of the base member 12. The HDD 10 is structured to include a fixed body portion, a rotating body portion, and a bearing unit that supports both in a relatively rotatable manner. In the present embodiment, a structure including all of the components for reading/writing data, such as the recording disk 20, the swing arm 22, the magnetic head 24, and the voice coil motor 18, is sometimes expressed as the HDD 10 or sometimes as the disk drive device. Or, sometimes only the components for rotationally driving the recording disk 20 are expressed as the disk drive device.

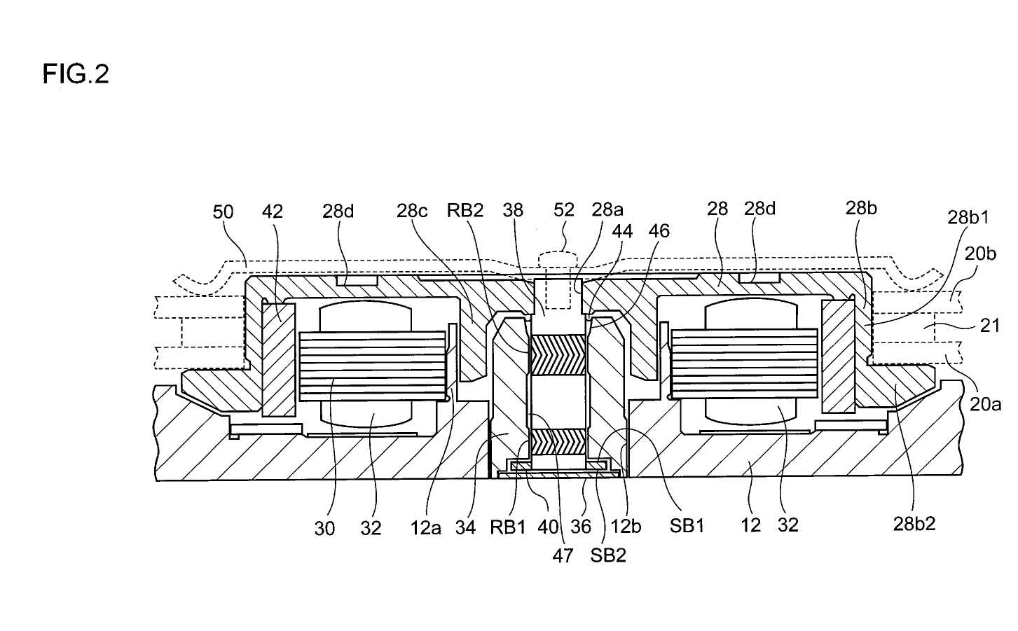

Details of the fixed body portion, the rotating body portion, and the bearing unit will be described with reference to FIG. 2. FIG. 2 illustrates, as an example, the structure of a so-called shaft-rotation-type disk drive device in which the hub member 28 supporting the recording disk 20 and a shaft 38, which will be described later, are integrally rotated.

The fixed body portion comprises the base member 12, a stator core 30, and a drive coil 32. The base member 12 serves also as a housing for the HDD 10. The stator core 30 is fixed to the outer wall surface of a cylinder portion 12a formed on the base member 12. The stator core 30 is structured by laminating electromagnetic steel plates and is provided with, for example, twelve radial-shaped teeth located at equal intervals along the circumference of the stator core 30, the teeth extending outwardly. The drive coil 32 is a three-phase coil wounded around the teeth of the stator core 30. A three-phase current having an approximate sine-wave shape is conducted through the drive coil 32 by a predetermined drive circuit such that a rotational magnetic field is generated. An approximately cylindrical-shaped sleeve 34, serving as a housing member, is fixed to a housing hole 12b formed on the base member 12. A disk-shaped counter plate 36 is fixed to one end of the sleeve 34, thereby sealing the inside of the base member 12 in which the recording disk 20, etc., is housed.

Subsequently, the rotating body portion will be described. The rotating body portion functions as a rotating member and is structured to include the hub member 28, the shaft 38, the flange 40, and a magnet 42. One end of the shaft 38 is fixed to a central hole 28a formed on the hub member 28, and the disk-shaped flange 40 is fixed to the other end of the shaft 38. The hub member 28 is an approximately cup-shaped member, concentric with the central hole 28a, and includes an outer circumferential cylinder portion 28b and an inner circumferential cylinder portion 28c. The cylindrical magnet 42 is fixed to the inner wall surface of the outer circumferential cylinder portion 28b with an adhesive, etc. The magnet 42 is formed of, for example, an Nd—Fe—B (Neodymium-Ferrum-Boron) rare earth material, and on the surface thereof an anti-corrosion treatment is performed by electro-deposition coating or spray coating, etc. In the present embodiment, the magnet 42 has, for example, eight driving magnetic poles along the circumferential direction thereof and on the inner circumference side thereof. The driving magnetic poles of the magnet 42 generate a rotational drive force, through the interaction with the rotational magnetic field generated by the drive of the drive coil 32 of the stator core 30, so that the rotating body portion is rotated. The hub member 28 can be formed by molding or machining a metal, such as aluminum and iron, or a conductive resin.

The outer circumferential cylinder portion 28b of the hub member 28 has an outer tube portion 28b1, extended in the axial direction of the shaft 38, and an outward extension portion 28b2, installed consecutively with the outer tube portion 28b1 and extending in the direction perpendicular to the axial direction, that is, extending outward in the radial direction of the recording disk 20. The hub member 28 is rotatably supported by the sleeve 34, which is to be a bearing unit, through the shaft 38. The hub member 28 according to the present embodiment supports two recording disks 20 arranged through a spacer 21. The outer tube portion 28b1 of the hub member 28 is engaged with the central hole of the recording disk 20a and the outward extension portion 28b2 supports the recording disk 20a. The spacer 21 is arranged on the upper surface of the recording disk 20a such that another recording disk 20b, engaged with the outer tube portion 28b1 of the hub member 28, is supported.

There is a need for weight saving of the HDD 10. Accordingly, a concave portions 28d are provided on the upper end surface of the hub member 28. The present inventors have obtained an experimental result showing that it is preferable to have, for example, six or more of the concave portions 28d provided at equal intervals along the circumferential direction of the hub member 28.

Subsequently, the bearing unit will be described. A radial space with a predetermined gap is formed in the radial direction that is perpendicular to the rotational axis direction of the rotating member, between the inner circumferential surface of the sleeve 34, which functions as the housing member, and the outer circumferential surface of the shaft 38. Radial dynamic pressure grooves RB1 and RB2 are formed on at least one of areas in the radial space, the areas facing each other. Specifically, on the inner circumference surface of the sleeve 34, for example, a pair of herringborn-shaped radial dynamic pressure grooves RB1 and RB2 is formed so as to be spaced apart from each other in the axial direction of the shaft 38, and a radial dynamic pressure generation portion that is structured with the radial dynamic pressure grooves RB1 and RB2 is formed. A radial fluid dynamic bearing is structured with the radial dynamic pressure generation portion and a lubricant, which will be described later. The radial dynamic pressure groove RB2 on the side close to the open end of the sleeve 34 is arranged at a level greater than or equal to the axial height of the surface on which the recording disk 20a supported by the outward extension portion 28b2 is mounted. With the radial dynamic pressure groove RB2 arranged on such a level, there is an effect that the hub member 28 is stably supported by dynamic pressure during its rotation.

In addition, a thrust space with a predetermined gap is formed in the axial direction of the rotating member by the shaft 38 and the sleeve 34, which functions as the housing member. Thrust dynamic pressure grooves SB1 and SB2 are formed on at least one of areas in the thrust space, the areas facing each other. Specifically, a thrust dynamic pressure generation portion, which is structured with the herringborn-shaped or spiral-shaped thrust dynamic pressure grooves SB1 and SB2, is formed on both the surface of the flange 40, which faces the end surface of the sleeve 34, and the surface of the flange 40, which faces the counter plate 36. A thrust fluid dynamic bearing is structured with the thrust dynamic pressure generation portion and a lubricant, which will be described later.

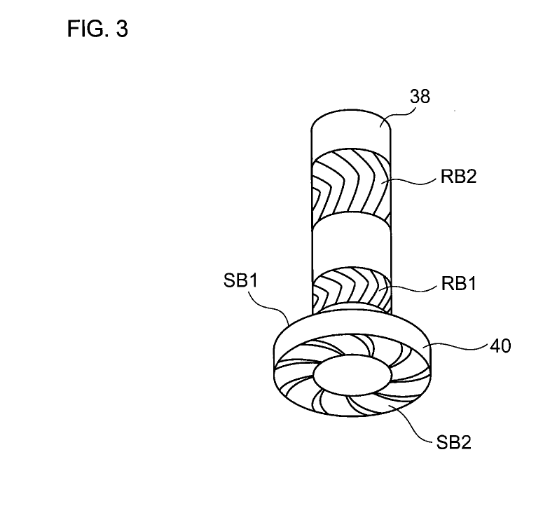

FIG. 3 is a perspective view of the shaft 38 provided with the flange 40. The radial dynamic pressure grooves RB1 and RB2 are formed on the surface of the shaft 38 and the thrust dynamic pressure groove SB2 is formed in the flange 40, facing the counter plate 36. The thrust dynamic pressure groove SB1 is formed on the surface of the flange 40, which is opposing the surface on which the thrust dynamic pressure groove SB2 is formed.

A capillary seal portion 44 is structured with the open end of the sleeve 34, in which the gap between the inner circumference of the sleeve 34 and the outer circumference of the shaft 38 gradually extends toward the outward of the capillary seal portion 44. The gap including the radial dynamic pressure grooves RB1 and RB2 and the thrust dynamic pressure grooves SB1 and SB2, and the gap, up until the middle of the capillary seal portion 44, are filled with a lubricant 46 such as oil. The radial dynamic pressure generation portion, including the radial dynamic pressure grooves RB1 and RB2, and the thrust dynamic pressure generation portion, including the thrust dynamic pressure grooves SB1 and SB2, communicate with each other by a circulation pathway 47 formed on part of the sleeve 34 or the inner circumferential surface thereof, etc., so that the lubricant 46 can freely circulate through each dynamic pressure generation portion.

When the shaft 38 of which the rotating body is composed is rotated by the rotational magnetic field generated by the drive of the drive coil 32 in the stator core 30, the radial dynamic pressure grooves RB1 and RB2 generate radial dynamic pressure in the lubricant 46, supporting the rotating body, including the hub member 28, in the radial direction. Further, when the flange 40 is rotated along with the shaft 38, the thrust dynamic pressure grooves SB1 and SB2 generate thrust dynamic pressure in the lubricant 46, supporting the rotating body including the hub member 28, in the thrust direction. The capillary seal portion 44 functions as a seal member for preventing the leakage of the lubricant 46, which occurs when an excessive amount of the lubricant 46 moves to the gap formed between the inner circumferential cylinder portion 28c and the sleeve 34 by capillarity.

In the disk drive device structured as stated above, the recording disk 20a and the recording disk 20b are mounted on the hub member 28 through the spacer 21. Further, the clamper 50 is mounted on the recording disk 20b such that the recording disks 20a and 20b are fixed to the hub member 28 with a screw 52. Thereby, the recording disk 20a, the spacer 21, and the recording disk 20b are integrally fixed to the hub member 28.

In the disk drive device structured as stated above, when the shaft including the flange 40 is rotated and when each of the radial dynamic pressure grooves RB1 and RB2, the thrust dynamic pressure grooves SB1 and SB2, and each of the facing surfaces have reached a predetermined relative rotational speed, dynamic pressure is generated in the lubricant 46 filled between both so that the gap between each dynamic pressure groove surface and the facing surface is maintained in a non-contact state. On the other hand, when the rotational speed is not enough, including the state when the shaft 38 is stopped, dynamic pressure is not generated, causing the dynamic pressure groove surface and the facing surface to be directly in contact with each other. In such a state, if the acceleration of an impact is applied to the disk drive device when, for example, something has fallen thereon, the dynamic pressure groove surface and the facing surface are to be in contact with each other in a state where kinetic energy is applied to the surfaces, the kinetic energy being given by the mass of the portion including the hub member 28 and the recording disk 20, etc., and by the impact acceleration, in which the portion is considered to be substantially integral with these surfaces. As a result, there is a fear that the dynamic pressure groove surface and the facing surface may be damaged or deformed.

Accordingly, in the present embodiment, at least one of the areas among where the thrust dynamic pressure groove SB is formed and where the radial dynamic pressure groove RB is formed is made of an impact absorbing body with a coefficient of elasticity less than or equal to 20 GPa. Specifically, a case will be taken into consideration in which, for example, the radial dynamic pressure grooves RB1 and RB2 are formed on the shaft 38 side and the thrust dynamic pressure grooves SB1 and SB2 are formed on the flange 40 side, and a stainless steel is used as the base material of the shaft 38 and the flange 40. In this case, the impact absorbing body is made of a material, for example, a polyetherimide resin, which is different from the base material of the shaft 38 and the flange 40, so that the base material is covered. In this case, it is desirable that the coefficient of elasticity of the impact absorbing body is less than or equal to 20 GPa, preferable that the coefficient of elasticity is less than or equal to 12 GPa, and more preferable that the coefficient of elasticity is less than or equal to 8 GPa. In the present embodiment, a coefficient of elasticity of 12 GPa and a tensile strength of 0.19 GPa can be realized by using a polyetherimide resin.

In this case, the coefficient of elasticity of the impact absorbing body is approximately one sixteenth ( 1/16) of the coefficient of elasticity of 200 GPa of a stainless steel, which has mainly been used before. When the dynamic pressure groove surface and the facing surface are in contact with each other, the kinetic energy of the impact is applied to the dynamic pressure groove surface; however, the kinetic energy is absorbed as a mechanical energy by the impact absorbing body, which covers the dynamic pressure groove surface. Because the stress applied to these surfaces is approximately proportional to the square root of the coefficient of elasticity, the stress is reduced to one fourth (¼) in comparison with the case of stainless steel. On the other hand, the tensile strength can be reduced to approximately one third (⅓) of that of a conventionally-used stainless steel, which is 0.52 GPa. That is, the stress at impact can be reduced to one fourth (¼) and the tensile strength to one third (⅓) by providing an impact absorbing body made of a polyetherimide resin. In this case, the following equation is held: strength of the impact absorbing body=(tensile strength)/(stress). That is, when compared to conventional components structured with a stainless steel, the following equation is held: {(tensile strength of stainless steel)×(⅓)}/{(stress of stainless steel)×(¼)}=(strength of stainless steel)×( 4/3)=(strength of stainless steel)×1.33. Accordingly, even at the component level, the strength is improved by approximately 33 percent relative to a conventional component made of stainless steel. That is, the strength against impact is improved.

As stated above, by forming at least one of the areas among where the thrust dynamic pressure groove SB is formed and where the radial dynamic pressure groove RB is formed, with an impact absorbing body with a coefficient of elasticity less than or equal to 20 GPa, the radial dynamic pressure generation portion and the thrust dynamic pressure generation portion can be made such that both are rarely deformed or damaged even in the case where the impact acceleration may be applied by, for example, handling during the assembly work. As a result, it becomes unnecessary to perform the handling work with excessive attention as done before. Thereby, the assembly work can be done more rapidly and easily, allowing for productivity to be improved.

The coefficient of linear expansion of the shaft 38 and the flange 40 according to the present embodiment, in which polyetherimide resin layers have been formed on the surfaces of the base material, such as stainless steel, is approximately 1×10⁻⁵ (1/° C.), which shows that the shaft 38 and the flange 40 according to the embodiment can be structured almost the same as conventional components, the whole of which are made of stainless steel. That is, the influence of the expansion due to the heat generated while the disk drive device is being operated can be made almost the same as a conventional one, the whole of which is made of stainless steel. As a resin other than a polyetherimide resin, a polyimide resin, a polyamide resin, etc., can likewise be used. In the aforementioned embodiment, an impact absorbing body made of a polyetherimide resin, etc., is formed on the surfaces of the base materials of the components of which the radial dynamic pressure generation portion and the thrust dynamic pressure generation portion are composed; however, similar effects as in the present embodiment can be obtained even by forming the shaft 38, the sleeve 34, the flange 40, etc., with which the radial dynamic pressure generation portion and the thrust dynamic pressure generation portion are structured, with a polyetherimide resin, etc.

In a disk drive device, a recording disk is sometimes charged with static electricity, caused by friction with ambient air, because the recording disk is rotationally driven. The collected static electricity may cause a discharge breakdown of the magnetic head or the destruction of data recorded on a recording disk. Accordingly, the components directly or indirectly leading to a recording disk, for example, the hub member, the shaft, the flange, the sleeve, etc., are formed with a conductive metal or the like in order to easily discharge the charged static electricity to the base member side. On the other hand, a lubricant with a volume resistivity of 1×10² to 10¹⁵ Ω·cm (at 20° C.) is generally used for filling the radial dynamic pressure generation portion and the thrust dynamic pressure generation portion, etc. Because the resistance value of the lubricant is larger than those of the aforementioned components, the lubricant is to be charged with the most static electricity. As a result, the lubricant will be degraded early. When there is a large difference between the volume resistivity of the lubricant used in a bearing unit and that of each component as stated above, static electricity is sometimes generated in the gap area between the resistance values during the assembly of a disk drive device. Thereby, the relevant members have sometimes been degraded or dust, etc., has sometimes been adsorbed. In particular, the adsorption of dust has sometimes caused a head crash. In this case, it is necessary to remove the static electricity in the assembly process of a disk drive device or to work slowly in order not to generate static electricity, both of which impede work efficiency.

Accordingly, in the present embodiment, the volume resistivity of at least one of the areas among where the thrust dynamic pressure groove is formed and where the radial dynamic pressure groove is formed is set to 1×10² to 10¹⁵ Ω·cm when the volume resistivity of the lubricant is 1×10² to 10¹⁵ Ω·cm. That is, by making the volume resistivity of the lubricant and those of the areas where the dynamic pressure grooves are formed equal to each other, it is designed that a potential difference is generated in an area other than the lubricant when static electricity is generated. Thereby, the concentration of static electricity in the lubricant is avoided, reducing the degradation of the lubricant.

In the present embodiment, when forming the impact absorbing body with a polyetherimide resin in the area where the thrust dynamic pressure groove SB is formed and in the area where the radial dynamic pressure groove RB is formed, a conductive filler such as carbon fiber is mixed into the polyetherimide resin, taking into consideration that it is easy to discharge static electricity to the base member side. Thereby, the volume resistivity of the impact absorbing body is adjusted to 1×10² to 10⁴ Ω·cm. By adjusting the volume resistivity to become such a range, the concentration of static electricity to be only in the lubricant can be suppressed when each of the areas where the thrust dynamic pressure groove SB is formed and where the radial dynamic pressure groove RB is formed is not in contact with its facing surface. Further, when each of the areas where the thrust dynamic pressure groove SB is formed and where the radial dynamic pressure groove RB is formed is in contact with its facing surface, a conduction effect can be obtained, allowing for static electricity to be discharged to the base member side. As a result, it becomes unnecessary to pay excessive attention to the generation of static electricity. For example, it becomes unnecessary to be excessively cautious so that static electricity is not generated during the assembly of a disk drive device. Further, it becomes unnecessary to add a process for discharging the static electricity or a member for preventing the charge of static electricity, allowing for productivity to be improved and for an increase in the component cost and in the manufacturing cost to be prevented.

When a disk drive device is in a non-driven state, for example, in a rotation-stopped state, the disk drive device has a function to remove static electricity, that is, a function to discharge the static electricity to the ground, as stated above. However, because the intrinsic resistance values of the lubricant and the components of the dynamic pressure groove surfaces vary, the function to discharge the static electricity varies accordingly. Therefore, in the disk drive device according to the present embodiment, the resistance value of each component is determined such that the electrical resistance between the base member 12 and the rotating member is less than 1 KΩ when the rotating member is in a non-rotating state. With such a determination in a disk drive device, the static electricity can be discharged even if the intrinsic resistance values of the lubricant and the components of the dynamic pressure groove surfaces vary. Thereby, the quality of a disk drive device can be maintained with minimal influence of static electricity.

As stated above, although static electricity is generated by the rotation of the recording disk 20, it can be designed so that the areas where the electric potential difference occurs, due to static electricity, are not concentrated in the lubricant, by minimizing the difference between the volume resistivity of the lubricant, used in the bearing unit, and that of either area where the thrust dynamic pressure groove SB is generated or area where the radial dynamic pressure groove RB is generated. As a result, a disk drive device can be designed so that the disk drive device is rarely affected by the influence of the static electricity during rotation of the disk drive device. However, there is sometimes the case where the disk drive device is slightly affected by the influence of static electricity because the intrinsic resistance values of the lubricant and the components of the dynamic pressure groove surfaces vary. Accordingly, in the disk drive device according to the present embodiment, the resistance value of each component is determined so that the electrical resistance between the base member 12 and the rotating member is less than 10 MΩ during the rotation of the rotating member. With such a determination, the quality of a disk drive device can be maintained with minimal influence from static electricity even when the intrinsic resistance values of the lubricant and the components of the dynamic pressure groove surfaces vary.

In the aforementioned embodiment, a so-called shaft-rotation-type disk drive device has been described as an example. As another example, in a disk drive device of another type, a similar effect as in the present embodiment can be obtained by structuring at least one of the areas among where the thrust dynamic pressure groove is formed and where the radial dynamic pressure groove is formed with an impact absorbing body with a coefficient of elasticity less than or equal to 20 GPa. For example, the aforementioned disk drive device of another type may be a so-called shaft-fixed type in which a bearing unit is rotatably supported by a shaft, fixed to part of a base member or the base member, and a hub member is fixed to the bearing unit. In addition, even in the shaft-rotation-type disk drive device, a type of the disk drive device in which a flange is not fixed to a shaft, the structure according to the present embodiment can be adopted. In the disk drive device of this type, the thrust dynamic pressure generation portion is formed between the flange, formed on the side facing the hub member of the circumferentially-provided housing arranged on the outer circumference of the sleeve, and the hub member facing the flange.

The structure according to the present embodiment can be adopted in a 3.5-inch type disk drive device and a 2.5-inch type, which can provide similar effects.

The present invention shall not be limited to the aforementioned embodiments, and various modifications, such as design modifications, can be made with respect to the above embodiments based on the knowledge of those skilled in the art. The structure illustrated in each drawing is intended to exemplify an example, and the structure can be appropriately modified to a structure having a similar function, which can provide similar effects.

What is claimed is:

1. A disk drive device comprising:
a base member;
a rotating member configured to rotate a recording disk; and
a bearing unit configured to rotatably support the rotating member relative to the base member, wherein the bearing unit includes:
a shaft;
a housing member with a hollow portion in which at least part of the shaft is housed and relative rotation is allowed;
a thrust dynamic pressure generation portion configured to generate dynamic pressure in the thrust direction in a thrust space with a predetermined gap, the thrust space being formed in the rotational axis direction of the rotating member by the shaft and the housing member, by the relative rotation between areas in the thrust space, the areas facing each other and a thrust dynamic pressure groove being formed on at least one of the areas;
a radial dynamic pressure generation portion configured to generate dynamic pressure in the radial direction in a radial space with a predetermined gap, the radial space being formed in the radial direction that is perpendicular to the rotational axis direction of the rotating member by the shaft and the housing member, by the relative rotation between areas in the radial space, the areas facing each other and a radial dynamic pressure groove being formed on at least one of the areas; and
a lubricant filled in the thrust space in the thrust dynamic pressure generation portion and the radial space in the radial generation portion, and wherein at least one of the areas among where the thrust dynamic pressure groove is formed and where the radial dynamic pressure groove is formed is an impact absorbing body with a coefficient of elasticity less than or equal to 20 GPa.

2. The disk drive device according to claim 1, wherein the impact absorbing body is made of a conductive resin material.

3. The disk drive device according to claim 1, wherein the impact absorbing body is formed so as to cover at least one of the surfaces of a base material of which the thrust dynamic pressure generation portion and the radial dynamic pressure generation portion are made.

4. The disk drive device according to claim 2, wherein the impact absorbing body is formed so as to cover at least one of the surfaces of a base material of which the thrust dynamic pressure generation portion and the radial dynamic pressure generation portion are made.

5. The disk drive device according to claim 1, wherein the volume resistivity of the lubricant and the volume resistivity of at least one of the areas among where the thrust dynamic pressure groove is formed and where the radial dynamic pressure groove is generated are similar to each other.

6. The disk drive device according to claim 2, wherein the volume resistivity of the lubricant and the volume resistivity of at least one of the areas among where the thrust dynamic pressure groove is formed and where the radial dynamic pressure groove is generated are similar to each other.

7. The disk drive device according to claim 5, wherein the volume resistivity of the lubricant is 1×10² to 10¹⁵ Ω·cm and the volume resistivity of the area where the thrust dynamic pressure groove is formed is 1×10² to 10¹⁵ Ω·cm.

8. The disk drive device according to claim 5, wherein the volume resistivity of the lubricant is 1×10² to 10¹⁵ Ω·cm and the volume resistivity of the area where the radial dynamic pressure groove is formed is 1×10² to 10¹⁵ Ω·cm.

9. The disk drive device according to claim 7, wherein the volume resistivity of the area where the radial dynamic pressure groove is formed is 1×10² to 10¹⁵ Ω·cm.

10. The disk drive device according to claim 1, wherein the electrical resistance between the base member and the rotating member is less than 1 KΩ when the rotating member is in a non-rotating state.

11. The disk drive device according to claim 1, wherein the electrical resistance between the base member and the rotating member is less than 10 KΩ when the rotating member is in a rotating state.

12. The disk drive device according to claim 1, wherein at least one of the areas among were the thrust dynamic pressure groove is formed and where the radial dynamic pressure groove is formed is an impact absorbing body with a coefficient of elasticity less than or equal to 12 GPa.

13. The disk drive device according to claim 1, wherein at least one of the areas among where the thrust dynamic pressure groove is formed and where the radial dynamic pressure groove is formed is an impact absorbing body with a coefficient of elasticity less than or equal to 8 GPa.
